(19) United States
(12) Patent Application Publication
(10) Pub. No.: US 2024/0360882 A1
(43) Pub. Date: Oct. 31, 2024

(54) Brake Wear Monitoring Sensor For Personal Vehicle

(71) Applicant: Robert bosch GmbH, Stuttgart (DE)

(72) Inventors: Heiko Erlenkeuser, Anderson, SC (US); Andy Woodrich, Northville, MI (US); Mark Rexrode, Anderson, SC (US)

(21) Appl. No.: 18/139,992

(22) Filed: Apr. 27, 2023

(51) Int. Cl. F16D 66/02; B32B 18/00; B62J 45/41; B62J 45/42; B62J 50/22; B62L 1/00; B62L 3/02; B62M 6/55; F16D 65/092

(52) U.S. Cl. CPC F16D 66/021; B32B 18/00; B62J 45/41; B62J 45/42; B62J 50/22; B62L 1/005; B62L 3/02; B62M 6/55; F16D 65/092; B32B 2605/00

(57) ABSTRACT

A brake pad assembly for a human-powered vehicle having a wear sensor and a number of probes surrounded by the tribological pad of the brake pad assembly. The wear sensor generates a signal indicating a wear condition of the tribological pad when one of the number of probes is agitated. The signal is transmitted via a transceiver circuit to an external processor, which may provide indications of wear condition to a user of the human-powered vehicle. The brake pad assembly may further comprise a tribological pad, base plate, wear sensor, and support for the transceiver circuit comprised of ceramic components.

### TECHNICAL FIELD

This disclosure relates to mechanical braking, and more particularly to mechanical braking and monitoring of brake wear in personal vehicles.

### BACKGROUND

Wheeled personal vehicles utilize braking mechanisms to control wheel rotation to slow the motion of the personal vehicle. Traditional braking mechanisms utilize tribological pads to create friction forces to slow the rotation of wheels during engagement of the brakes. Tribological pads necessarily wear down with usage and must be periodically replaced. Near the end of the lifespan of the tribological pads additionally may exhibit non-ideal braking behavior.

What is desired is a brake for use with a wheeled personal vehicle that provides a ready indication of the current wear condition of the brake's tribological pad to a user of the personal vehicle. Additional improvements in the material composition of the tribological pad may additionally extend the usable lifespan of the brake between service actions.

### SUMMARY

One aspect of this disclosure is directed to a human-powered vehicle having a braking system. The human-powered vehicle comprises a human-propulsion component configured to rotate a wheel in response to human work input. The braking system comprises a brake caliper disposed about the wheel and configured to apply a braking force to the wheel, a base plate mounted upon the brake caliper, a tribological pad mounted upon the base plate, the tribological pad comprising a number of ceramic layers, and a wear sensor mounted upon the base plate. The wear sensor has a number of probes embedded within the tribological pad, the wear sensor generating a signal in response to an agitation of one of the number of probes. The braking system further comprises a transceiver circuit in data communication with the wear sensor, the transceiver circuit configured to emit signals from the wear sensor to a processor. The human-powered vehicle additionally comprises a power source in power connection with the wear sensor and the transceiver circuit and a human-machine interface (HMI) in data communication with the processor. In this embodiment, the caliper is actuated using a brake control in cable connection with the caliper. With additional regard to this embodiment, each of the number of ceramic layers are arranged to form a sequence of strati in a direction perpendicular to the base plate, wherein each of the number of probes terminates in a different one of the number of ceramic layers. In some embodiments, additional elements of the braking system may be comprised of ceramic components.

Another aspect of this disclosure is directed to a brake system for a human-powered vehicle, comprising a brake caliper, a base plate mounted upon the brake caliper, and a tribological pad mounted upon the base plate, the tribological pad comprising a number of layers. The brake system additionally comprises a wear sensor mounted upon the base plate, the wear sensor having a number of probes embedded within the tribological pad, the wear sensor generating a number of signals in response to agitation of one of the number of probes. The brake system additionally comprises a transceiver circuit in data communication with the wear sensor, the transceiver circuit configured to emit signals from the wear sensor to a receiver. The brake system additionally comprises a power source in power connection with the wear sensor and the transceiver circuit. In this embodiment, the caliper is actuated using a brake control in cable connection with the caliper. With further respect to this embodiment, each of the number of layers are arranged to form a sequence of strati in a direction perpendicular to the base plate, wherein each of the number of probes terminates in a different one of the number of layers.

A further aspect of this disclosure is directed to a brake pad assembly comprising a base plate and a tribological pad mounted upon the base plate, the tribological pad comprising a number of layers. The brake pad additionally comprises a wear sensor mounted upon the base plate. The brake pad additionally comprises a number of probes in electrical communication with the wear sensor and embedded within the tribological pad. The brake pad additionally comprises a transceiver circuit in data communication with the wear sensor, the transceiver circuit is configured to transmit signals emitted from the wear sensor to a receiver. In this embodiment, each of the number of layers are arranged to form a sequence of strati in a direction perpendicular to the base plate, each of the number of probes terminates in a different one of the number of layers, and the wear sensor generates a signal in response to an agitation of one of the probes. In additional embodiments, components of the brake pad may be comprised of a ceramic material composition.

The above aspects of this disclosure and other aspects will be explained in greater detail below with reference to the attached drawings.

### BRIEF DESCRIPTION OF THE DRAWINGS

FIG. 1 is an illustration of electric bicycle having a brake system with enhanced features.

FIG. 2 is an illustration of a brake pad of a brake system having enhanced features.

FIG. 3 is a cross-sectional diagrammatic of features of the brake pad of FIG. 2.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

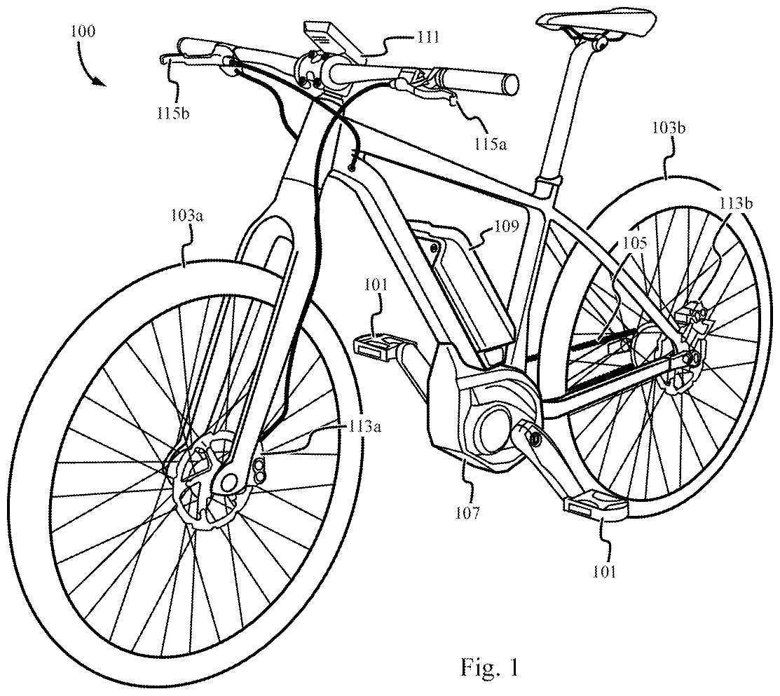

FIG. 1 shows a human-powered vehicle according to one embodiment of the invention disclosed herein. In the depicted embodiment, the human-powered vehicle comprises a bicycle (or “bike”) 100, but other embodiments may comprise a different human-powered vehicle, such as a tricycle, quadricycle, unicycle, velocipede, velomobile, scooter, hand-powered bike, recumbent bicycle, recumbent tricycle, or any other personal vehicle that may transport at least one person and comprises a braking system without deviating from the teaching disclosed herein. In the depicted embodiment, bike 100 comprises an electric bicycle having a pedal-assist function, but other embodiments may comprise other configurations without deviating from the teachings disclosed herein. Other such embodiments may comprise conventional unassisted vehicles, throttle-assisted vehicles, or vehicles having motors or prime movers powered by means other than human input or electric input without deviating from the teachings disclosed herein.

In the depicted embodiment, bike 100 comprises a pedal-powered bike having pedals 101 to accept human-powered inputs to drive a wheel 103 via a drive 105. In the depicted embodiment, the drive comprises a chain 105 and bike 100 is a chain-driven bike 100 propelled by human input. The human input is transferred from pedals 101 to chain 105, and chain 105 provides rotational forces to a rear wheel 103b, while a front wheel 103a freely rotates passively. Other embodiments may comprise other configurations without deviating from the teachings disclosed herein. In some such embodiments, the drive may comprise a belt or other propulsion mechanism without deviating from the teachings disclosed herein.

A powered mover may additionally provide forces to the chain 105. In the depicted embodiment, the powered mover comprises an electric motor 107 that provides assistive force in response to human input. Other embodiments may provide force in response to a throttle or other controlling mechanism without deviating from the teachings disclosed herein. In the depicted embodiment, motor 107 is powered via a bike battery 109 that is in disposed upon the frame of bike 100 and in electrical communication with motor 107. Additional functional characteristics of the motor 107 may be controlled by a user via a processor 111 in data communication with motor 107. Processor 111 may comprise a head unit configured to operate some electrical functions of bike 100. Processor 111 may comprise a mobile processing device such as a smart phone running an application configured to interface with electrical functions of bike 100. Processor 111 provides a human-machine interface (HMI) configured to permit a user to interact with processor 111. In the depicted embodiment, the HMI may comprise a combination of hardware buttons and a touchscreen, but other embodiments may comprise other configurations of HMI having additional or additional elements without deviating from the teachings disclosed herein. The HMI may comprise soft buttons, audio input, audio outputs, voice control or speech control inputs, haptic outputs, remotely-disposed control elements, or any other interface components recognized by one of ordinary skill without deviating from the teachings disclosed herein.

In some embodiments, a combination of processors 111 may be utilized to control functions of bike 100. In some embodiments, processor 111 may comprise a general-purpose processor that can be modularly detached from an interface that is disposed upon the frame of bike 100. Other embodiments may comprise other configurations of processor 111 without deviating from the teachings disclosed herein.

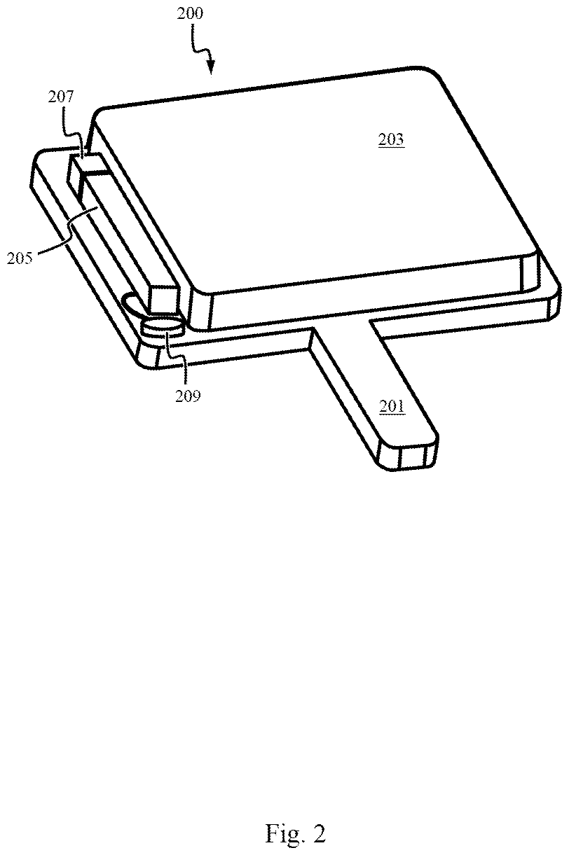

In the depicted embodiment, bike 100 additionally comprises a braking system for a user to apply braking forces to the wheels 103 in order to slow the motion of bike 100. The braking system of the depicted embodiment includes brakes 113, and brake controls 115. In the depicted embodiment, brakes 113 comprise disc-style brakes that apply braking forces to a disc component of a respective wheel 103 by actuating a caliper. Other embodiments may comprise other brake configurations, such as non-caliper brakes or rim-style brakes that apply braking forces to a rim of a wheel 103, without deviating from the teachings disclosed herein. In the depicted embodiment, each brake 113 is independently controlled by a respective brake control 115. In this embodiment, each brake control 115 comprises a hand-brake control mechanism in cable connection with the calipers of its respective brake 113. Each of brake 113 comprises a number of brake pad assemblies (not shown; see FIG. 2) that provide the braking and friction forces necessary to slow the rotation of a wheel 103. These brake pad assemblies are comprised of materials that are subject to wear during normal use and are subject to periodic replacement. It would be advantageous to provide users with brake pad assemblies that provide feedback regarding the level of wear experienced by brake pad assemblies of brakes 113. The feedback would primarily be useful to avoid wear conditions of the brake pad assemblies that may result in sub-optimal braking function.

Additional features of such a brake pad assembly 200 are illustrated in FIG. 2. Brake pad assembly 200 is comprised of a base plate 201 and a tribological pad 203 disposed thereon. Tribological pad 203 is configured to interface with components of a wheel in order to apply braking forces to the wheel. Tribological pad 203 is further configured as a sacrificial component, wherein the braking interaction will wear away the contact surface of tribological pad 203 instead of damaging the corresponding component of the wheel during braking.

In the depicted embodiment, each of base plate 201 and tribological pad 203 may be comprised of ceramic materials or ceramic composites. It is important to select ceramic materials or ceramic composites that are suitable to withstand the expected forces applied during braking of the associated vehicle (such as a human powered vehicle 100; see FIG. 1). Vehicles that are sufficiently fast-moving, heavy, or carrying sufficiently heavy loads may present difficulty or expense in implementing ceramic or ceramic-composite configurations of base plate 201 and/or tribological pad 203. In some such embodiments, other materials with greater resiliency may be utilized in lieu of ceramics, or as part of a ceramic-composite.

Also disposed upon base plate 201 is a wear sensor 205 configured to generate signals corresponding to wear conditions of the tribological pad 203. In the depicted embodiment, wear sensor 205 generates a plurality of signals, each of the plurality of signals generated in response to a different state of tribological pad 203, but other embodiments may comprise other configurations—such as a single signal being generated only in response to a single particular condition of tribological pad 203—without deviating from the teachings disclosed herein.

Also disposed upon base plate 201 is a transceiver circuit 207 in data communication with the wear sensor 205 and configured to transmit the signals to an external receiver (such as processor 111; see FIG. 1). In the depicted embodiment, transceiver circuit 207 comprises a wireless transmitter, but other embodiments may comprise other configurations having a wired transmitter, a wired receiver, or a wireless receiver without deviating from the teachings disclosed herein. In the depicted embodiment, the wireless transmission protocol used comprises a radio frequency identifier (RFID) protocol, and transceiver circuit 207 comprises an RFID emitter, but other embodiments may comprise other protocols without deviating from the teachings disclosed herein. In the depicted embodiment, transceiver circuit 207 is supported by a ceramic support. A ceramic support is advantageously less susceptible to corrosion from operating conditions and the elements, which provides a greater degree of protection to the functional electric connections between transceiver circuit 207 and wear sensor 205.

Also depicted in this embodiment is a battery 209 in electrical communication with wear sensor 205 and transceiver circuit 207. In the depicted embodiment, battery 209 is disposed upon base plate 201 alongside other elements of brake pad assembly 200. In some embodiments, battery 209 may be otherwise disposed or may be absent from brake pad assembly 200 entirely without deviating from the teachings disclosed herein. By way of example, and not limitation, some embodiments may instead be in electrical communication with a battery not disposed upon brake pad assembly 200, such as bike battery 109 (see FIG. 1), without deviating from the teachings disclosed herein.

Advantageously, some embodiments of brake pad assembly 200 may utilize a passive form of wireless connectivity, such as passive RFID, for transceiver circuit 207. In such embodiments, brake pad assembly 200 comprises no battery 209 without deviating from the teachings disclosed herein. In such embodiments, the energy necessary for transmission of the transceiver circuit 207 or generation of signals by wear sensor 205 may come from alternative energy sources, such as an induction circuit, regenerative braking sources, dynamo hub, or an excitation signal from an external element. In the embodiments utilizing passive RFID connectivity for the transceiver circuit 207, the receiver of the signals, such as processor 111 (see FIG. 1), generates interrogating signals to acquire the signals from brake pad assembly 200, and the interrogating signals are utilized as excitation signals to power the circuit. Other embodiments may comprise other configurations without deviating from the teachings disclosed herein.

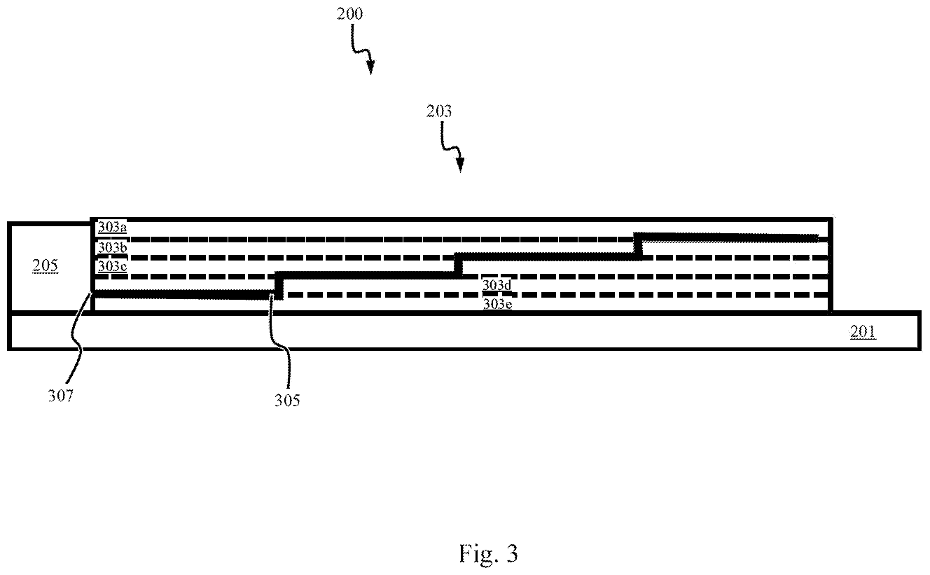

Additional features of brake pad assembly 200 are illustrated in the diagrammatic illustration of FIG. 3. In this diagrammatic, a diagrammatic cross-section is illustrated, showing an arrangements of additional features. In particular, tribological pad 203 is shown to be comprised of a number of layers 303 extending perpendicularly away from base plate 201. In the depicted embodiment, tribological layer 203 is comprised of five layers, but other embodiments may have different configurations without deviating from the teachings disclosed herein. Layers 303 may be physically implemented in different ways, such as implementing different material configurations in one or more layers or utilizing additive manufacturing techniques to create strata within the tribological pad 203 during manufacture. The layers 303 may also be abstract layers, merely providing a general indication of measurement of the thickness of tribological pad 203 without actually comprising a physically distinct strata within the pad. In the depicted embodiment, tribological pad 203 comprises abstract layers 303, which are useful primarily as measurement references for the thickness of tribological pad 203 to observe the wear thereof with normal use of the brakes.

Extending from wear sensor 205 is a number of probes 305. Each probe 305 extends into a different one of the number of layers 303, and is used to generate a signal by wear sensor 205 when agitated, such as by a component of a wheel (such as wheel 103, see FIG. 1). Probes 305 may comprise a electromagnetic, ferromagnetic, piezoelectric, or other material that is suitable to generate an electrical signal when agitated or in contact with a component external to tribological pad 203. In the depicted embodiment, a set of 4 cascading probes 305 are in electrical connection with wear sensor 205 via a connection port 307. In the depicted embodiment, each of the number of probes 303 is disposed within tribological pad 203 at a transition point between two layers 303 within the pad. Other embodiments may utilize other configurations without deviating from the teachings disclosed herein. Some embodiments may comprise a different number of probes without deviating from the teachings disclosed herein. One such alternative embodiment may comprise a single probe disposed within a single layer 303 of tribological pad 203, but other embodiments having additional probes 305 disposed amongst additional layers 303 advantageously enables wear sensor 205 to generate different signals corresponding to different levels of wear of tribological pad 203.

In the depicted embodiment, probes 305 are dispersed in a sequential cascade, with each probe segment extending from another probe segment. Such an implementation advantageously reduces costs by minimizing the number of ports 307. This implantation is accomplished by utilizing the total impedance of the cascading probes 305 with respect to wear sensor 205 in generating a signal. Notably, such an embodiment additionally relies upon the probes 305 wearing away with utilization of the brakes in a manner similar to the surrounding ceramic material of tribological pad 203. Each of the probes 303 is agitated when exposed to outside conditions because the immediately surrounding tribological material has worn away.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A brake pad assembly comprising:
a base plate;
a tribological pad mounted upon the base plate, the tribological pad comprising a number of layers;
a wear sensor mounted upon the base plate,
a number of probes in electrical communication with the wear sensor and embedded within the tribological pad; and
a transceiver circuit in data communication with the wear sensor, the transceiver circuit is configured to transmit signals emitted from the wear sensor to a receiver,
wherein
each of the number of layers are arranged to form a sequence of strati in a direction perpendicular to the base plate,
each of the number of probes terminates in a different one of the number of layers, and the wear sensor generates a signal in response to an agitation of one of the number of probes.

2. The brake pad assembly of claim 1, wherein the transceiver circuit comprises a radio frequency identification (RFID) emitter.

3. The brake pad assembly of claim 1, wherein each of the number of layers comprises a ceramic layer.

4. The brake pad assembly of claim 1, wherein the number of probes are arranged in a sequential cascade having a number of extensions, each extension corresponding to a transition in the tribological pad between adjacent layers.

5. The brake pad assembly of claim 1, wherein the transceiver circuit is supported by a ceramic support, the ceramic support comprising a circuit board or a housing.

6. A brake system for a human-powered vehicle, comprising:
a brake caliper;
a base plate mounted upon the brake caliper;
a tribological pad mounted upon the base plate, the tribological pad comprising a number of layers;
a wear sensor mounted upon the base plate, the wear sensor having a number of probes embedded within the tribological pad, the wear sensor generating a number of signals in response to agitation of one of the number of probes;
a transceiver circuit in data communication with the wear sensor, the transceiver circuit configured to emit signals from the wear sensor to a receiver; and
a power source in power connection with the wear sensor and the transceiver circuit,
wherein the brake caliper is actuated using a brake control in cable connection with the brake caliper, wherein each of the number of layers are arranged to form a sequence of strati in a direction perpendicular to the base plate, and wherein each of the number of probes terminates in a different one of the number of layers.

7. The brake system of claim 6, further comprising:
a processor in data communication with the receiver; and
a human-machine interface (HMI) in data communication with the processor,
wherein the processor is configured to generate an alert for a user in response to receiving a signal from the transceiver circuit and present the alert to a user via the HMI.

8. The brake system of claim 7, wherein the processor and HMI are embodied by a mobile computing device in wireless data communication with the transceiver circuit.

9. The brake system of claim 7, wherein the processor and the HMI are embodied by a head unit of an electric bicycle.

10. The brake system of claim 9, wherein the head unit is in wired data communication with the transceiver circuit.

11. The brake system of claim 6, wherein the power source comprises a battery.

12. The brake system of claim 11, wherein the battery is suitable to supply power to a motor of an electric bicycle.

13. The brake system of claim 11, wherein the battery is disposed upon the base plate.

14. The brake system of claim 6, wherein the transceiver circuit comprises a radio frequency identification (RFID) emitter.

15. A human-powered vehicle having a braking system comprising:
a human-propulsion component configured to rotate a wheel in response to human work input;
a brake caliper disposed about the wheel and configured to apply a braking force to the wheel;
a base plate mounted upon the brake caliper;
a tribological pad mounted upon the base plate, the tribological pad comprising a number of ceramic layers;
a wear sensor mounted upon the base plate, the wear sensor having a number of probes embedded within the tribological pad, the wear sensor generating a signal in response to an agitation of one of the number of probes;
a transceiver circuit in data communication with the wear sensor, the transceiver circuit configured to emit signals from the wear sensor to a processor;
a power source in power connection with the wear sensor and the transceiver circuit; and
a human-machine interface (HMI) in data communication with the processor,
wherein the brake caliper is actuated using a brake control in cable connection with the brake caliper, wherein each of the number of ceramic layers are arranged to form a sequence of strati in a direction perpendicular to the base plate, and wherein each of the number of probes terminates in a different one of the number of ceramic layers.

16. The human-powered vehicle of claim 15, wherein the transceiver circuit is supported by a ceramic support, the ceramic support comprising a circuit board or a housing.

17. The human-powered vehicle of claim 15, wherein the human-powered vehicle comprises an electric bicycle, wherein the processor and the HMI are embodied by a head unit of the electric bicycle, and wherein the head unit is in wired data communication with the transceiver circuit.

18. The human-powered vehicle of claim 15, wherein the human-powered vehicle comprises an electric bicycle, wherein the power source comprises a battery in electric communication with a motor of the electric bicycle.

19. The human-powered vehicle of claim 15, wherein the transceiver circuit comprises a radio frequency identification (RFID) emitter.

20. The human-powered vehicle of claim 15, wherein the number of probes are arranged in a sequential cascade having a number of extensions corresponding to the number of ceramic layers of the tribological pad.
